(19) United States
(12) Patent Application Publication
(10) Pub. No.: US 2018/0132551 A1
(43) Pub. Date: May 17, 2018

(54) Ornamental hood and garment

(71) Applicant: Winston Bartholomew Holder, III, Uniondale, NY (US)

(72) Inventor: Winston Bartholomew Holder, III, Uniondale, NY (US)

(21) Appl. No.: 15/350,012

(22) Filed: Nov. 12, 2016

(51) Int. Cl. A41D 15/00; A41D 1/04; A41D 3/08; A41D 27/02; A41D 31/00; A01K 13/00

(52) U.S. Cl. CPC A41D 15/00; A41D 1/04; A41D 3/08; A41D 27/02; A41D 2400/60; A01K 13/006; A41D 2200/20; A41D 2300/33; A41D 31/0011

(57) ABSTRACT

An ornamental design for a hood that can be applied to any garment and said garment wherein a hole or space in the back of the hood allows the wearer of the garment's head to pass through the hole or space. The application allows any garment to be worn both ways.

### BACKGROUND OF THE INVENTION

The present invention relates to a hood, in particular for all garments and articles of clothing such as sweatshirts, shirts, jackets, capes. coats, scarves, and the like. The present invention further relates to clothing items, which are equipped with such a hood.

Further the invention also relates to the use of a hole or space cut or sewn into the hood. Said hole or space allows for the wearer's head to pass through transitioning the garment or article from a hooded garment or article of clothing to a non-hooded garment or article of clothing.

One fundamental idea of the present invention is thus to equip the above describe hole or space in the hood with a hem, creating a channel for a drawstring, which further allows any garment or article of clothing to be worn two ways.

In the use state, i.e., when the wearer's head is pulled through the hole or space in the hood, the drawstring can be engaged to allow the wearer added face and neck protection from the elements and airborne debris.

The term “hole or space in hood” as used herein in relation to the hood is to be understood for the purposes of the present invention not only in its narrow sense but also in a wider sense. Therefore the hole or space in the hood can designate: a state where the head can pass through the top, back, and or sides of the hood but also a state where the hood has two loose ends (fro example when the hood comprises a closure or a closable opening), in which case the two loose ends of the hood can be zipped, buttoned or at least brought together at the ends.

This too shall for the purposes of the present invention also be understood as subsumed by the above described hem at hole or space in hood can be sewn, raw, cinched with a drawstring, have elastic sewn or glued or essentially with the ability to be opened and closed at will.

### BRIEF SUMMARY OF THE INVENTION

A hood, in particular for all garments and articles of clothing or the like, according to one embodiment of the present invention includes a hole within the hood of the garment which allows the wearer's head to pass through said hole or space in the use state.

Further advantages, properties, aspects, and features of the present invention will be apparent from the following description of a preferred operative example depicted in the drawings.

### BRIEF DESCRIPTION OF THE DRAWINGS

FIG. 1: is a front elevation view of my inventive garment and hood showing my new design;

FIG. 2: is a left side elevation view thereof. This illustration shows the hole of the hood in both the open and cinched closed positions;

FIG. 3: is a right side elevation view thereof. This illustration shows the hole of the hood in both the open and cinched closed positions;

FIG. 4: is a back elevation view thereof;

FIG. 5: is a front elevation view of the garment in FIG. 1, but with head pulled through hole or space in hood;

FIG. 6: is a right side elevation view of the garment in FIG. 1, but with head pulled through hole or space in hood;

FIG. 7: is a left side elevation view of the garment in FIG. 1, but with head pulled through hole or space in hood;

FIG. 8: is a back elevation view of the garment in FIG. 1, but with head pulled through hole or space in hood;

FIG. 9: is a front elevation view of the hood of the garment in FIG. 1

FIG. 10: is a rear elevation view of the hood of the garment in FIG. 1

FIG. 11: is a side elevation view of the hood of the garment in FIG. 1. Both left and right sides are identical.

FIG. 12: is a front elevation view of the hood of the garment in FIG. 1, but with head pulled through hole or space in hood;

FIG. 13: is a rear elevation view of the hood of the garment in FIG. 1, but with head pulled through hole or space in hood;

FIG. 14: is a side elevation view of the hood of the garment in FIG. 1, but with head pulled through hole or space in hood. Both left and right sides are identical;

FIG. 15: is a top plan view of the hood of the garment in FIG. 1;

FIG. 16: is a bottom plan view of the hood of the garment in FIG. 1;

### BRIEF DESCRIPTION OF A PREFERRED EMBODIMENT

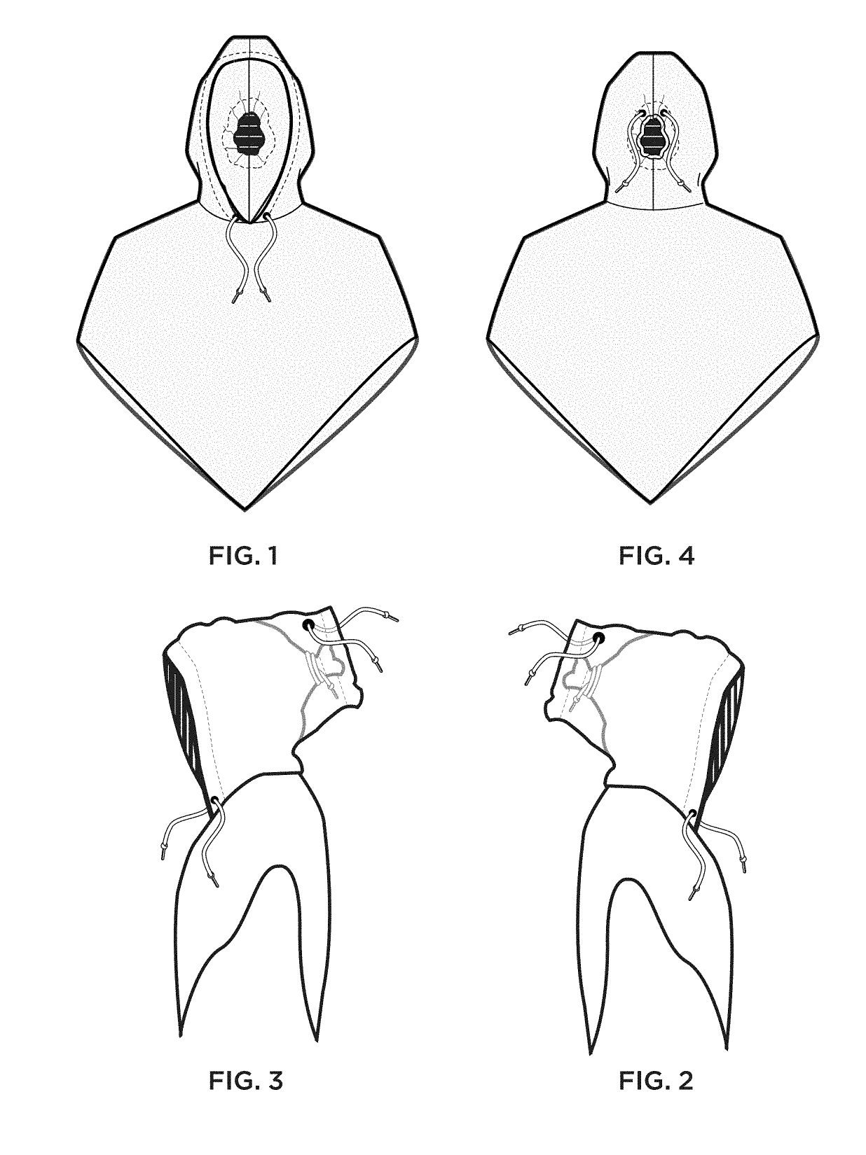

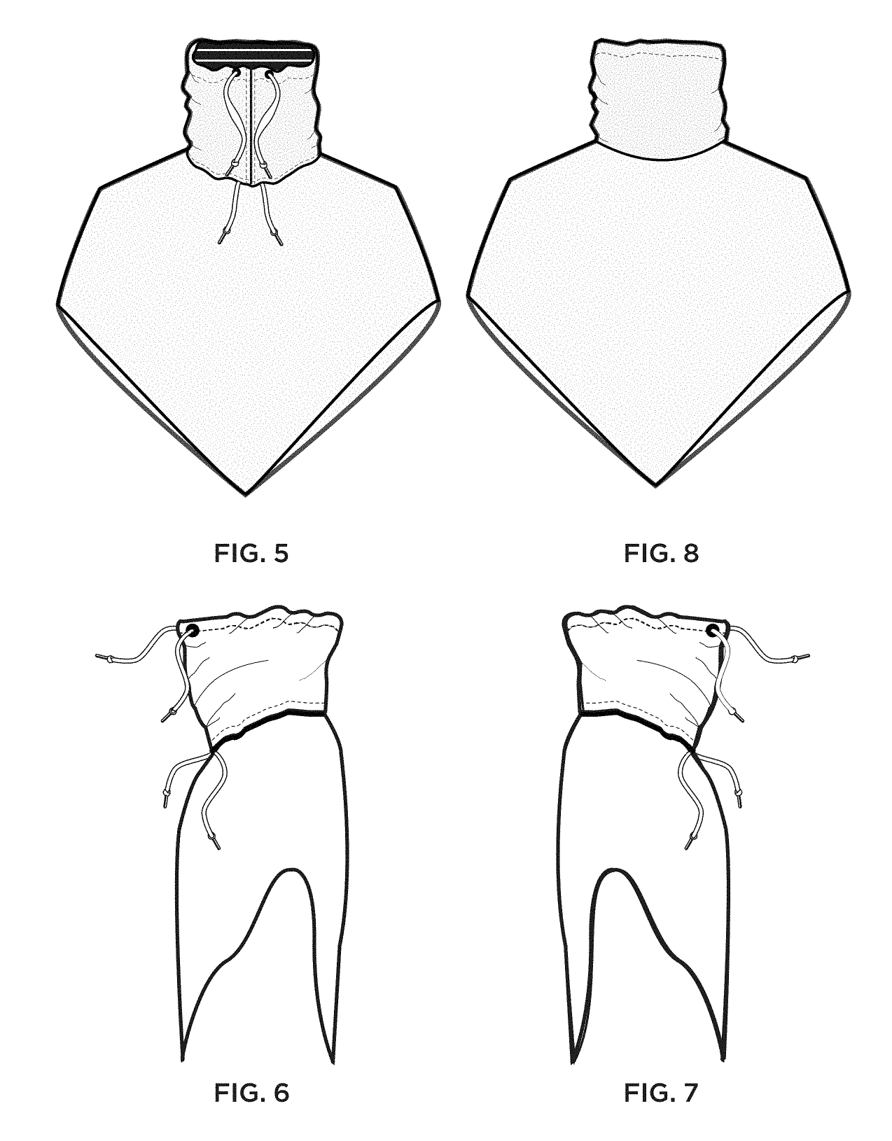

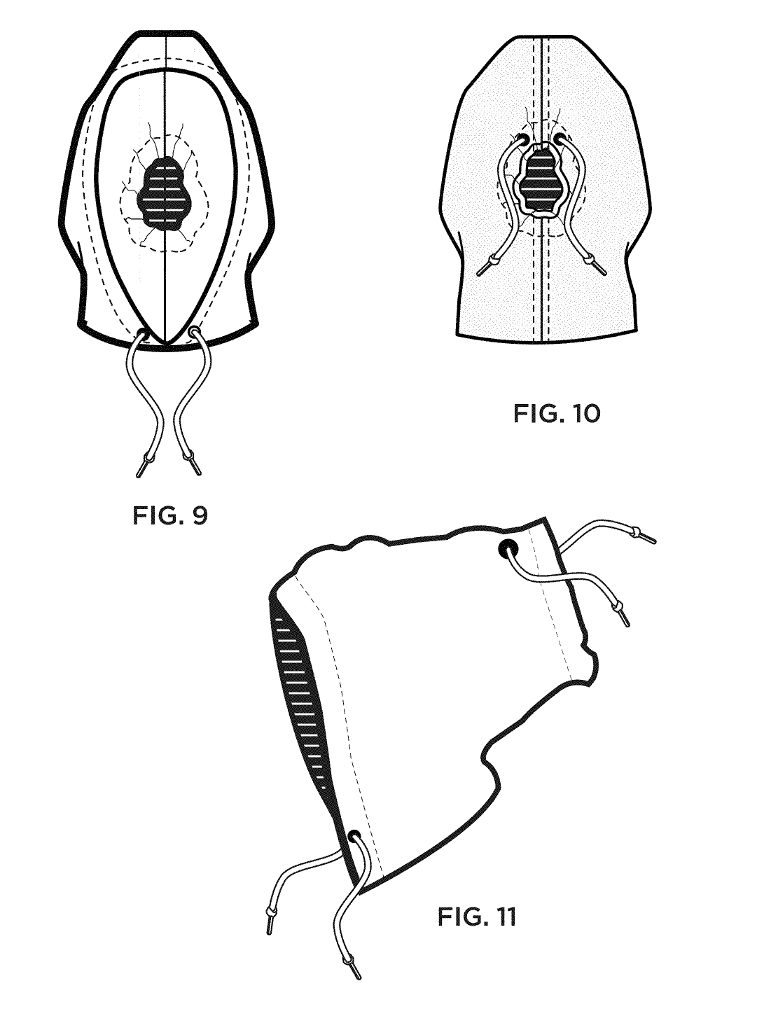

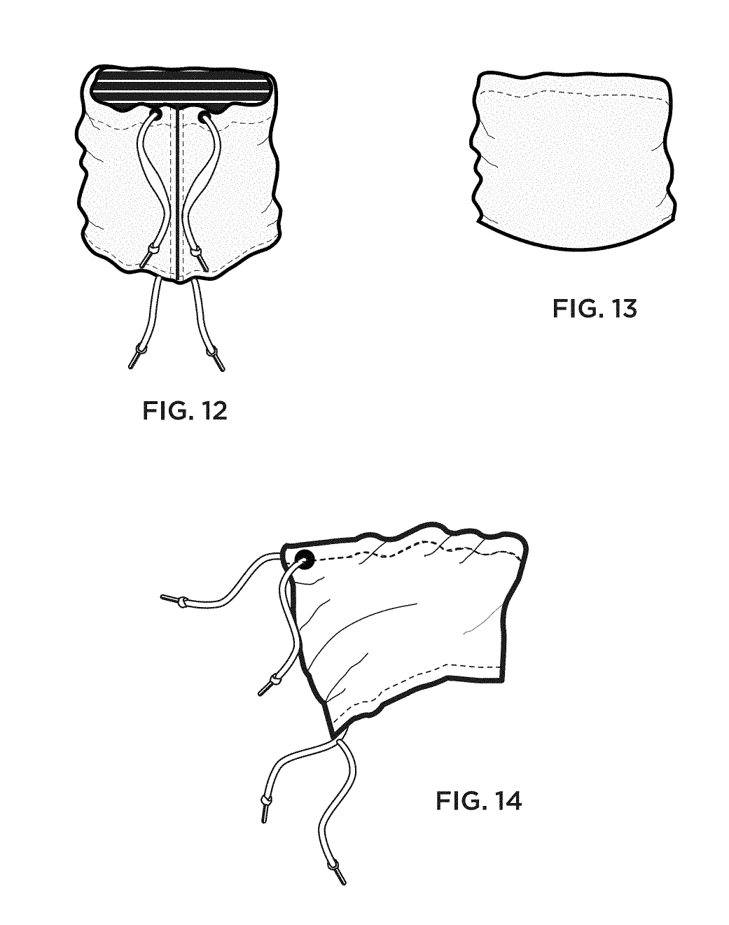

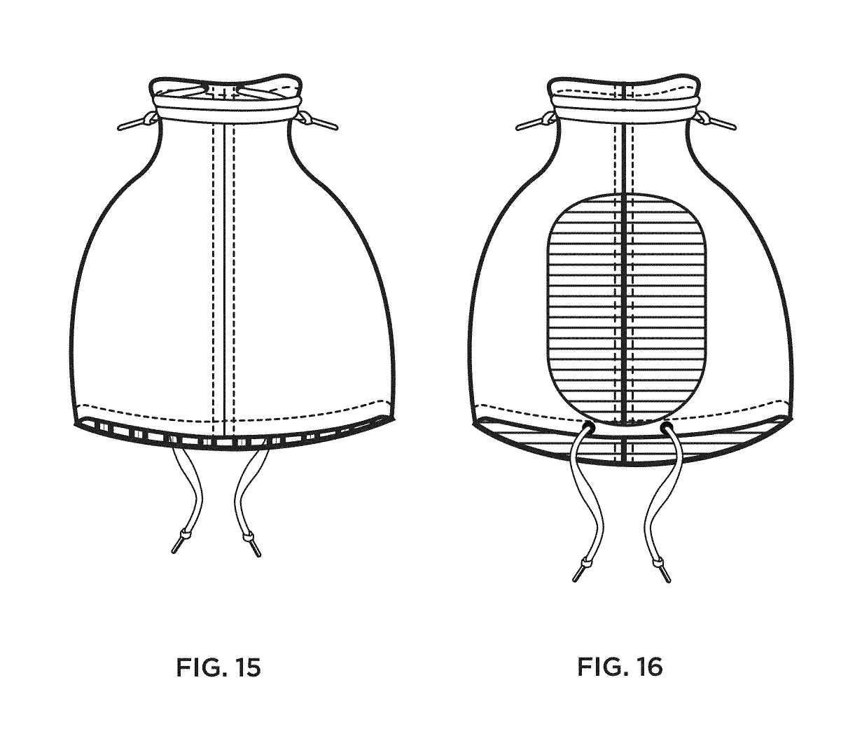

Referring to the drawings, FIG. 1-FIG. 16 indicates a combination garment of my design comprising a cape and hood.

I do not wish to be limited to the specific embodiment shown and described or uses mentioned, but intend the same to be merely exemplary, the scope and claim of our invention shall encompass the use of said ornamental hood on all garments and all garments for animals.

The invention is claimed as:

1. The ornamental design for a hood, in particular for a garment, and said garment, such as but not limited to a sweatshirt, cape, jacket, or coat, said hood comprising: a hood body with a hole or space in the hood, said hole or space giving the ability of transforming a hooded garment to a non-hooded garment by allowing the wearer's head to pass through said hole or space in the hood, said hole being a space cut or stitched into hood of substantial width to allow wearer's head to pass thru the hood, wherein a peripheral hem of said hole or space is applied to create a space for drawstring(s) shown and described.

2. The hood according to claim 1, wherein the hole or space in the hood is not hemmed.

3. The hood according to claim 1, wherein the hem of the hole or space in the hood is secured by using one of the securing methodologies selected from the group consisting of stitching, interweaving, adhering, stapling, and gluing.

3. The hood according to claim 1, wherein the hem of the hole or space in the hood is secured by using elastic or an elastic strip.

3. The hood according to claim 1, wherein the hole or space in the hood is made from elastic or an elastic material.

3. The hood according to claim 1, wherein the hood, hole, or space in the hood is made from knit or an elastic material.

4. The hood according to claim 1, wherein the hood including the face opening and hole or space in hood comprises, on the side portion of hood, a fastener.

5. The hood according to claim 1, wherein the hood includes a liner on its inside surface.

6. The hood according to claim 1, wherein the hood includes a liner on its inside surface with an inside material, the inside material comprising a material selected from the group consisting of: (i) an adsorption-capable material on the basis of activated carbon, and (ii) a water-vapor-pervious, but gas-impervious barrier layer preventing or retarding the passage of harmful gases and liquids.

7. A garment comprising a hood as defined in claim 1.

8. A garment for animals comprising a hood as defined in claim 1.

9. The garment according to claim 7, wherein the clothing item includes a liner on its inside surface with an inside material, the inside material comprising a material selected from the group consisting of: (i) an adsorption-capable material on the basis of activated carbon, and (ii) a water-vapor-pervious, but gas-impervious barrier layer preventing or retarding the passage of harmful gases and liquids.

10. A method for transitioning a hooded garment or article of clothing into a non-hooded garment or article of clothing by using a hole or space in the hood, comprising the steps of: providing a hole or space in hood where in hole or space is large enough to allow the wearer's head to pass through the hole or space in hood.
